(19) United States
(12) Patent Application Publication
(10) Pub. No.: US 2018/0339796 A1
(43) Pub. Date: Nov. 29, 2018

(54) PREFILLED SYRINGE FILLING MACHINE

(71) Applicant: TRUKING TECHNOLOGY LIMITED, Hunan (CN)

(72) Inventors: Tianqiao BAI, Hunan (CN); Dayu CAI, Hunan (CN); Xinhua LI, Hunan (CN); Wei PENG, Hunan (CN); Huaizhou ZHOU, Hunan (CN)

(73) Assignee: TRUKING TECHNOLOGY LIMITED, Hunan (CN)

(21) Appl. No.: 15/778,230

(22) PCT Filed: Dec. 2, 2016
(86) PCT No.: PCT/CN2016/108369

§ 371 Date: May 23, 2018

(30) Foreign Application Priority Data
Dec. 31, 2015 (CN) 201511014289.3

(51) Int. Cl. B65B 31/02; B65B 65/00; A61J 1/20; B65B 69/00

(52) U.S. Cl. CPC B65B 31/025; B65B 65/003; B67C 2007/006; B65B 69/00; A61J 1/20

(57) ABSTRACT

The present invention discloses a prefilled syringe filling machine, including an external package removal area, an internal package removal area, a filling and stoppering area being arranged to be adjacent to the internal package removal area, a rubber plug buffer area and a conveyor belt penetrating through the internal package removal area from the external package removal area, a first transfer device is arranged in the internal package removal area; a second transfer device is arranged in the filling and stoppering area; a material delivery port is arranged between the filling and stoppering area and the internal package removal area; at work, the first transfer device transfers materials on the conveyor belt to the material delivery port so as to deliver the materials to the second transfer device, the second transfer device carries the materials and, after accomplishing filling and stoppering the materials, transfers the materials to the material delivery port so as to deliver the materials to the first transfer device, and the first transfer device transfers the materials onto the conveyor belt. The present invention has the advantages of having a simple structure and being able to effectively reduce the risk of drug contamination.

### FIELD OF THE INVENTION

The present invention relates to medicine production equipment, and in particular to a prefilled syringe filling machine.

### DESCRIPTION OF RELATED ART

In the prior art, a prefilled syringe filling machine is generally divided into three areas, namely an external package removal area, an internal package removal area and a filling and stoppering area, the external package removal area has different cleanliness level requirements from the internal package removal area and the filling and stoppering area, the internal package removal area and the filling and stoppering area are usually installed in an environment with a higher cleanliness level. The internal package removal area generally includes four stations of preheating, film tearing, lining paper striping and transferring, an unpacked prefilled syringe is conveyed by a conveyor belt to the filling and stoppering area, a feeding and discharging swing arm in the filling and stoppering area grabs a syringe tray, places the same onto a mobile platform and transfers the syringe tray to the filling and stoppering area, and the mobile platform conveys the syringe tray to a grabbing station of the feeding and discharging swing arm after the filling and stoppering are accomplished and conveys the tray to the conveyor belt to be output. The above technical solution has the problems of complicated structure, many stations, cleaning and maintenance difficulty, and a large risk of drug contamination caused by the large disturbance of the vertical flow in the high-level clean area when the components move, etc.

### BRIEF SUMMARY OF THE INVENTION

The technical problem to be solved by the present invention is to overcome the shortcomings of the prior art and provide a prefilled syringe filling machine which has a simple structure and can effectively reduce the risk of drug contamination.

To solve the above technical problem, the present invention adopts the following technical solutions:

A prefilled syringe filling machine includes an external package removal area, an internal package removal area, a filling and stoppering area, a rubber plug buffer area and a conveyor belt, the conveyor belt penetrating through the internal package removal area from the external package removal area, and the filling and stoppering area being arranged to be adjacent to the internal package removal area, wherein a first transfer device is arranged in the internal package removal area; a second transfer device is arranged in the filling and stoppering area; a material delivery port is arranged between the filling and stoppering area and the internal package removal area, at work, the first transfer device transfers materials on the conveyor belt to the material delivery port so as to deliver the materials to the second transfer device, the second transfer device carries the materials and, after accomplishing filling and stoppering, transfers the materials to the material delivery port so as to deliver the materials to the first transfer device, and the first transfer device transfers the materials onto the conveyor belt.

As a further improvement of the above technical solution:

The external package removal area, the internal package removal area and the filling and stoppering area are linearly arranged successively, the conveyor belt extends to the outer side of the filling and stoppering area, and the rubber plug buffer area is arranged to be adjacent to the filling and stoppering area.

The first transfer device is a first transfer mechanical arm, and a transfer fixture capable of clamping the materials is installed on the first transfer mechanical arm.

The second transfer device is a second transfer mechanical arm, and a hollow frame-shaped bracket capable of supporting the materials is installed on the second transfer mechanical arm.

A film tearing fixture and a lining paper removal fixture are further installed on the first transfer mechanical arm.

An internal package removal device is further arranged in the internal package removal area, and the internal package removal device includes a film tearing fixture and a lining paper removal fixture.

An empty material collection box and a waste material collection port are further arranged in the internal package removal area, and the empty material collection box is arranged on one side of the conveyor belt.

A filling component and a stoppering component are further installed on the second transfer mechanical arm.

A filling pump and a plug arrangement hopper are further arranged in the filling and stoppering area, the filling pump is connected with the second transfer mechanical arm, and the plug arrangement hopper is arranged between the rubber plug buffer area and the second transfer mechanical arm.

The conveyor belt is located on one side in the external package removal area and the internal package removal area.

Compared with the prior art, the present invention has the following advantages:

According to the prefilled syringe filling machine of the present invention, the conveyor belt does not penetrate through the filling and stoppering area, the material delivery port is arranged between the filling and stoppering area and the internal package removal area, and the delivery of the materials between the internal package removal area and the filling and stoppering area is achieved by the first transfer device and the second transfer device, so that the internal package removal area and the filling and stoppering area are relatively independent and the transfer of the materials between the two areas is not affected, thus the disturbance of the vertical flow in the high-level clean area during the input and output of the conveyor belt is avoided, and the risk of drug contamination is reduced.

### BRIEF DESCRIPTION OF THE DRAWINGS

FIG. 1 is a top view of a prefilled syringe filling machine of the present invention.

FIG. 2 is a three-dimensional structural diagram of the prefilled syringe filling machine of the present invention.

FIG. 3 is a three-dimensional structural diagram of the prefilled syringe filling machine of the present invention at another viewing angle.

FIG. 4 is a schematic diagram of material delivery at a material delivery port of the prefilled syringe filling machine of the present invention.

### REFERENCE SIGNS

1. external package removal area; 2. internal package removal area; 22. empty material collection box; 23. waste material collection port; 3. filling and stoppering area; 31. filling pump; 32. plug arrangement hopper; 4. rubber plug buffer area; 5. conveyor belt; 6. material delivery port; 7. first transfer device; 71. transfer fixture; 8. second transfer device; 81. hollow frame-shaped bracket.

### DETAILED DESCRIPTION OF THE INVENTION

The present invention will be further described in detail below in conjunction with the accompanying drawings and specific embodiments.

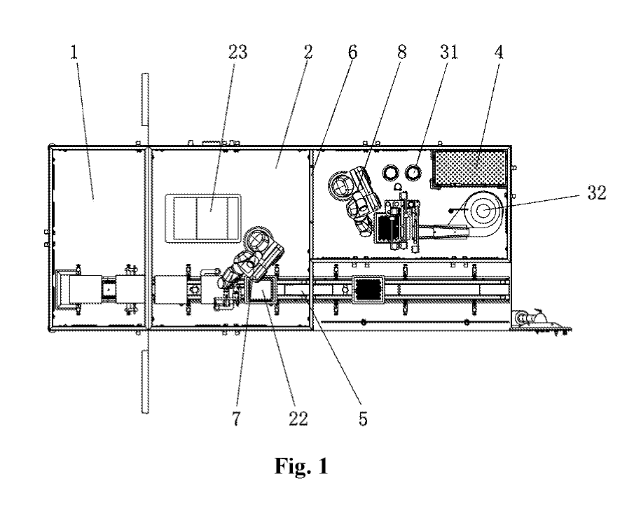

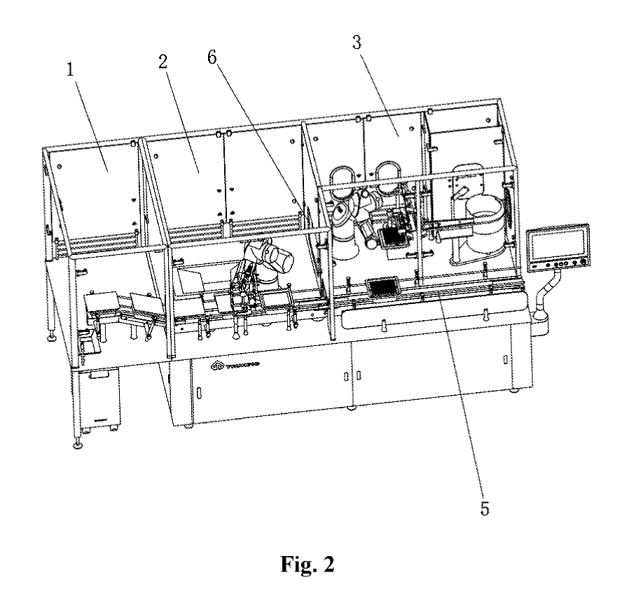

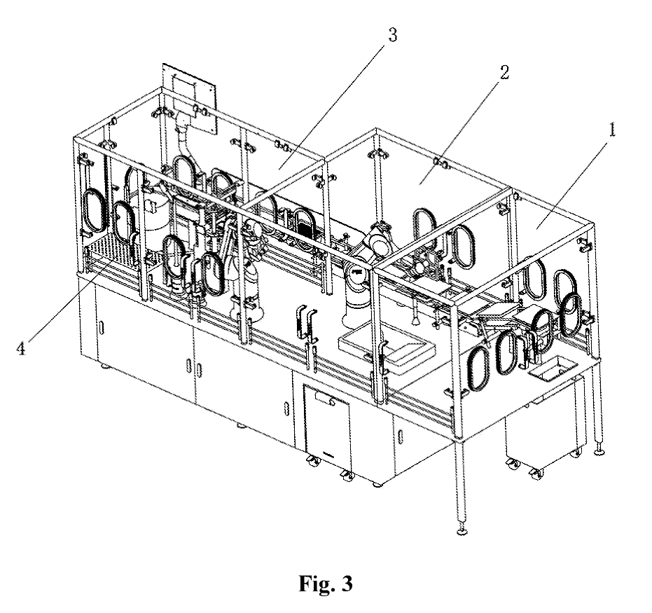

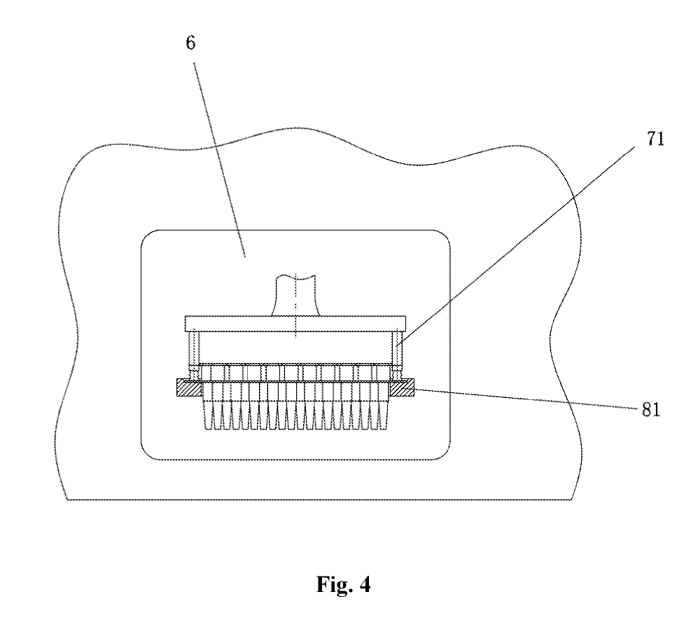

FIGS. 1 to 4 show an embodiment of a prefilled syringe filling machine of the present invention. The prefilled syringe filling machine includes an external package removal area 1, an internal package removal area 2, a filling and stoppering area 3, a rubber plug buffer area 4 and a conveyor belt 5, the conveyor belt 5 penetrating through the internal package removal area 2 from the external package removal area 1, and the filling and stoppering area 3 being arranged to be adjacent to the internal package removal area 2, wherein a first transfer device 7 is arranged in the internal package removal area 2; a second transfer device 8 is arranged in the filling and stoppering area 3; a material delivery port 6 is arranged between the filling and stoppering area 3 and the internal package removal area 2; at work, the first transfer device 7 transfers materials on the conveyor belt 5 to the material delivery port 6 so as to deliver the materials to the second transfer device 8, and the second transfer device 8 carries the materials and, after accomplishing filling and stoppering, transfers the materials to the material delivery port 6 so as to deliver the materials to the first transfer device 7, and the first transfer device 7 transfers the materials onto the conveyor belt 5; the conveyor belt 5 does not penetrate through the filling and stoppering area 3, the material delivery port 6 is arranged between the filling and stoppering area 3 and the internal package removal area 2, the delivery of the materials between the internal package removal area 2 and the filling and stoppering area 3 is achieved by the first transfer device 7 and the second transfer device 8, so that the internal package removal area 2 and the filling and stoppering area 3 are relatively independent and the transfer of the materials between the two areas is not affected, thus the disturbance of the vertical flow in the high-level clean area during the input and output of the conveyor belt 5 is avoided, and the risk of drug contamination is reduced.

The materials in the present embodiment mainly refer to a prefilled syringe packaging box and a prefilled syringe tray.

In the present embodiment, the external package removal area 1, the internal package removal area 2 and the filling and stoppering area 3 are linearly arranged successively, the conveyor belt 5 extends to the outer side of the filling and stoppering area 3, and the rubber plug buffer area 4 is arranged to be adjacent to the filling and stoppering area 3.

In addition to the arrangement solution in the present embodiment, the filling and stoppering area can also be located between the external package removal area and the internal package removal area as long as it is arranged to be adjacent to the internal package removal area.

In the present embodiment, the first transfer device 7 is a first transfer mechanical arm, a transfer fixture 71 capable of clamping the materials is installed on the first transfer mechanical arm, the second transfer device 8 is a second transfer mechanical arm, a hollow frame-shaped bracket 81 capable of supporting the materials is installed on the second transfer mechanical arm, the transfer fixture 71 is moved to right above the prefilled syringe packaging box by the first transfer mechanical arm, the transfer fixture 71 is located to suck the prefilled syringe tray in the prefilled syringe packaging box, then the first transfer mechanical arm moves to convey the prefilled syringe tray to the material delivery port 6, meanwhile the second transfer mechanical arm drives the hollow frame-shaped bracket 81 to move to the material delivery port 6, and the hollow frame-shaped bracket 81 sleeves the prefilled syringe tray on the transfer fixture 71 from the lower side.

In the present embodiment, a film tearing fixture and a lining paper removal fixture are further installed on the first transfer mechanical arm, that is, film tearing and lining paper removal operations can be accomplished under the drive of the first transfer mechanical arm, thereby further simplifying the structure and reducing the transfer frequency of the materials.

In addition to the structures in the present embodiment, an internal package removal device can also be further arranged in the internal package removal area 2, and the internal package removal device includes a film tearing fixture and a lining paper removal fixture, that is, the transfer fixture 71, the film tearing fixture and the lining paper removal fixture are separately arranged.

In the present embodiment, an empty material collection box 22 and a waste material collection port 23 are further arranged in the internal package removal area 2, the empty material collection box 22 is arranged on one side of the conveyor belt 5, and after the hollow frame-shaped bracket 81 sleeves the prefilled syringe tray on the transfer fixture 71 from the lower side, the transfer fixture 71 conveys the prefilled syringe packaging box onto the conveyor belt 5 so as to convey the same into the empty material collection box 22, and the waste material collection port 23 is used for collecting external films and lining paper.

In the present embodiment, a filling component and a stoppering component are further installed on the second transfer mechanical arm, the hollow frame-shaped bracket 81 carries the prefilled syringe tray, and the filling component and the stoppering component perform filling and stoppering operations, thereby further simplifying the structure and reducing the transfer frequency of the prefilled syringe tray.

In the present embodiment, a filling pump 31 and a plug arrangement hopper 32 are further arranged in the filling and stoppering area 3, the filling pump 31 is connected with the second transfer mechanical arm, and the plug arrangement hopper 32 is arranged between the rubber plug buffer area 4 and the second transfer mechanical arm.

In the present embodiment, the conveyor belt 5 is located on one side in the external package removal area 1 and the internal package removal area 2 to facilitate picking and placing the materials.

Although the present invention has been disclosed in the above preferred embodiments, it is not intended to limit the present invention. Any skilled in the art can make many possible changes and modifications to the technical solutions of the present invention, or modify the technical solutions of the present invention into equivalent embodiments of equivalent changes, by using the technical contents disclosed above without departing from the scope of the technical solutions of the present invention. Therefore, any simple modifications, equivalent changes and modifications made to the above embodiments according to the technical essence of the present invention without departing from the contents of the technical solutions of the present invention shall fall within the protection scope of the technical solutions of the present invention.

1. A prefilled syringe filling machine, comprising an external package removal area, an internal package removal area, a filling and stoppering area being arranged to be adjacent to the internal package removal area, a rubber plug buffer area and a conveyor belt penetrating through the internal package removal area from the external package removal area, wherein a first transfer device is arranged in the internal package removal area; a second transfer device is arranged in the filling and stoppering area; a material delivery port is arranged between the filling and stoppering area and the internal package removal area; at work, the first transfer device transfers materials on the conveyor belt to the material delivery port so as to deliver the materials to the second transfer device, the second transfer device carries the materials and, after accomplishing filling and stoppering the materials, transfers the materials to the material delivery port so as to deliver the materials to the first transfer device, and the first transfer device transfers the materials onto the conveyor belt.

2. The prefilled syringe filling machine of claim 1, wherein the external package removal area, the internal package removal area and the filling and stoppering area are linearly arranged successively, the conveyor belt extends to the outer side of the filling and stoppering area, and the rubber plug buffer area is arranged to be adjacent to the filling and stoppering area.

3. The prefilled syringe filling machine of claim 1, wherein the first transfer device is a first transfer mechanical arm, and a transfer fixture capable of clamping the materials is installed on the first transfer mechanical arm.

4. The prefilled syringe filling machine of claim 3, wherein the second transfer device is a second transfer mechanical arm, and a hollow frame-shaped bracket capable of supporting the materials is installed on the second transfer mechanical arm.

5. The prefilled syringe filling machine of claim 3, wherein a film tearing fixture and a lining paper removal fixture are further installed on the first transfer mechanical arm.

6. The prefilled syringe filling machine of claim 3, wherein an internal package removal device is further arranged in the internal package removal area, and the internal package removal device comprises a film tearing fixture and a lining paper removal fixture.

7. The prefilled syringe filling machine of claim 1, wherein an empty material collection box and a waste material collection port are further arranged in the internal package removal area, and the empty material collection box is arranged on one side of the conveyor belt.

8. The prefilled syringe filling machine of claim 4, wherein a filling component and a stoppering component are further installed on the second transfer mechanical arm.

9. The prefilled syringe filling machine of claim 8, wherein a filling pump and a plug arrangement hopper are further arranged in the filling and stoppering area, the filling pump is connected with the second transfer mechanical arm, and the plug arrangement hopper is arranged between the rubber plug buffer area and the second transfer mechanical arm.

10. The prefilled syringe filling machine of claim 1, wherein the conveyor belt is located on one side in the external package removal area and the internal package removal area.

11. The prefilled syringe filling machine of claim 2, wherein the conveyor belt is located on one side in the external package removal area and the internal package removal area.

12. The prefilled syringe filling machine of claim 3, wherein the conveyor belt is located on one side in the external package removal area and the internal package removal area.

13. The prefilled syringe filling machine of claim 4, wherein the conveyor belt is located on one side in the external package removal area and the internal package removal area.

14. The prefilled syringe filling machine of claim 5, wherein the conveyor belt is located on one side in the external package removal area and the internal package removal area.

15. The prefilled syringe filling machine of claim 6, wherein the conveyor belt is located on one side in the external package removal area and the internal package removal area.

16. The prefilled syringe filling machine of claim 7, wherein the conveyor belt is located on one side in the external package removal area and the internal package removal area.

17. The prefilled syringe filling machine of claim 8, wherein the conveyor belt is located on one side in the external package removal area and the internal package removal area.

18. The prefilled syringe filling machine of claim 9, wherein the conveyor belt is located on one side in the external package removal area and the internal package removal area.
